(19) United States
(12) Patent Application Publication
(10) Pub. No.: US 2016/0093458 A1
(43) Pub. Date: Mar. 31, 2016

(54) DIRECT CURRENT RELAY

(71) Applicant: LSIS CO., LTD., Anyang-si (KR)

(72) Inventor: Jung Sik AN, Seoul (KR)

(73) Assignee: LSIS CO., LTD., Anyang-si (KR)

(21) Appl. No.: 14/746,732

(22) Filed: Jun. 22, 2015

(30) Foreign Application Priority Data
Sep. 29, 2014 (KR) 20-2014-0007089

(51) Int. Cl. H01H 50/38; H01H 51/22; H01H 50/18; H01H 50/54

(52) U.S. Cl. CPC H01H 50/38; H01H 50/54; H01H 51/2209; H01H 50/18; H01H 2201/008; H01H 2051/2218

(57) ABSTRACT

The present invention relates to a direct current relay, and more particularly, to a direct current relay capable of reducing an electronic repulsive force generated between a fixed contact and a movable contact by a permanent magnet installed to extinguish an arc. The direct current relay includes: a frame; first and second fixed contacts spaced from each other with a predetermined distance there between; first and second magnetic substances formed to enclose a lower part of the first and second fixed contacts; a movable contact movable to contact or to be separated from the first and second fixed contacts, having a first movable contact contactable to the first fixed contact, and having a second movable contact contactable to the second fixed contact; and a pair of permanent magnets installed on long sides of the frame.

### CROSS-REFERENCE TO RELATED APPLICATION

Pursuant to 35 U.S.C. §119(a), this application claims the benefit of earlier filing date and right of priority to Korean Patent Application No. 20-2014-0007089, filed on Sep. 29, 2014, the contents of which are all hereby incorporated by reference herein in its entirety.

### BACKGROUND OF THE INVENTION

1. Field of the Invention

The present invention relates to a direct current relay, and more particularly, to a direct current relay capable of reducing an electronic repulsive force generated between a fixed contact and a movable contact by a permanent magnet installed to extinguish an arc.

2. Background of the Invention

Generally, a direct current (DC) relay or a electromagnetic contactor is a type of electric circuit switching apparatus for performing a mechanical driving and transmitting a current signal using a principle of an electromagnet. The DC relay or the electromagnetic contactor is installed at various types of industrial equipment, machines, vehicles, etc.

FIG. 1 is a sectional view of a direct current relay in accordance with the conventional art, and FIG. 2 is an inner perspective view illustrating an upper part of FIG. 1.

The conventional direct current relay includes a lower frame 1, an upper frame 2, a pair of fixed contacts and a pair of movable contacts installed in the upper frame 2, and an electric actuator 5 installed in the lower frame 1 and configured to drive the movable contacts 4 so that a connected state between the fixed contacts 3 and the movable contacts 4 can be switched by an electric signal. Permanent magnets 6a, 6b are provided in the upper frame 2 so as to effectively control an arc generated when the contacts are separated from each other.

The pair of fixed contacts 3 are configured as a first fixed contact 3a and a second fixed contact 3b, and have polarities of (+), (−), respectively. The permanent magnets 6a, 6b installed in the upper frame 2 form a magnetic field (B), and are fixed by a permanent magnet holder (not shown). The magnetic field (B) generated from the permanent magnets 6a, 6b interacts with a current (+I, −I), thereby generating a force (+f, −f) to push out an arc generated when the contacts are separated from each other. This can reduce damage of a contact part.

However, the conventional direct current relay has the following problems.

Firstly, when the permanent magnets 6a, 6b for controlling an arc are provided at the direct current relay, a current (I) flows on the movable contacts 4 from a first movable contact 4a to a second movable contact 4b as shown in FIG. 2. Thus, a force (F) is applied to the movable contacts 4 in a downward direction by Fleming's law. The force (F) is applied in a direction to separate the movable contacts 4 from the fixed contacts 3. Such a force is called an ‘electrodynamic repulsion force’. In a normal current state, no problem occurs. However, when an over-current flows due to a fault current, the electrodynamic repulsion force is drastically increased, resulting in separation of the contact part. As a result, the fixed contact 3 and the movable contact 4 are separated from each other, and thus an inferior contact state may be caused.

FIG. 3 illustrates a magnetic flux density in a direct current relay in accordance with the conventional art, which shows a flow of a magnetic field (B) formed by the permanent magnets 6a, 6b. The magnetic field (B) flows in a direction toward the lower permanent magnet 6b from the upper permanent magnet 6a. It can be shown that a magnetic flux density within a range between the upper permanent magnet 6a and the lower permanent magnet 6b is almost constant.

### SUMMARY OF THE INVENTION

Therefore, an aspect of the detailed description is to provide a direct current relay capable of reducing an electro repulsive force generated between a fixed contact and a movable contact, by a permanent magnet installed to extinguish an arc.

To achieve these and other advantages and in accordance with the purpose of this specification, as embodied and broadly described herein, there is provided a direct current relay, including: a frame; first and second fixed contacts spaced from each other with a predetermined distance therebetween; first and second magnetic substances formed to enclose a lower part of the first and second fixed contacts; a movable contact movable to contact or to be separated from the first and second fixed contacts, having a first movable contact contactable to the first fixed contact, and having a second movable contact contactable to the second fixed contact; and a pair of permanent magnets installed on long sides of the frame.

The first and second fixed contacts may be formed so that head parts, body parts, and leg parts form steps sequentially. The first and second magnetic substances may be coupled to a circumferential surface of the body parts or the leg parts.

Each of the first and second magnetic substances may be formed to have a ‘C’ shape.

Open parts of the first and second magnetic substances may be installed so as to be toward outside.

The first and second magnetic substances may be configured as ferromagnetic substances, or may be configured as paramagnetic substances.

The direct current relay according to a first embodiment of the present invention has the following advantage.

A magnetic flux flowing from the permanent magnet is concentrated to the first and second magnetic substances, since the first and second magnetic substances are provided below the first and second fixed contacts. As a result, an electronic repulsive force generated between the fixed contacts and the movable contacts can be reduced by the permanent magnet installed to extinguish an arc.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from the detailed description.

### BRIEF DESCRIPTION OF THE DRAWINGS

The accompanying drawings, which are included to provide a further understanding of the invention and are incorporated in and constitute a part of this specification, illustrate exemplary embodiments and together with the description serve to explain the principles of the invention.

In the drawings:

FIG. 1 is a sectional view of a direct current relay in accordance with the conventional art;

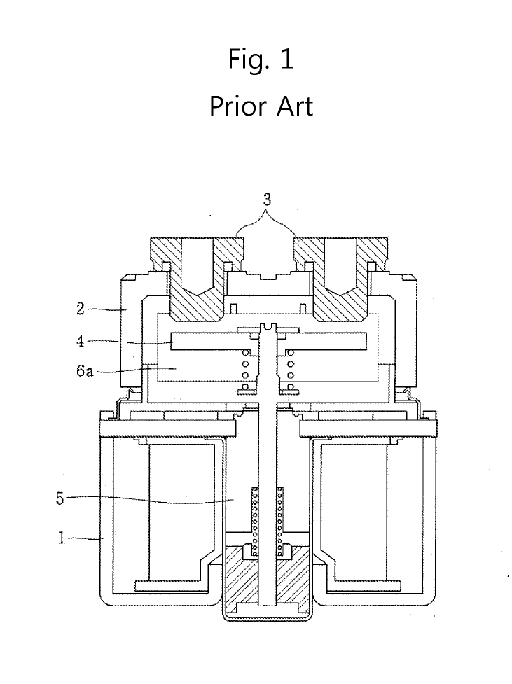

FIG. 2 is an inner perspective view illustrating an upper part of FIG. 1, which shows a relation of a force applied between a contact part and a permanent magnet;

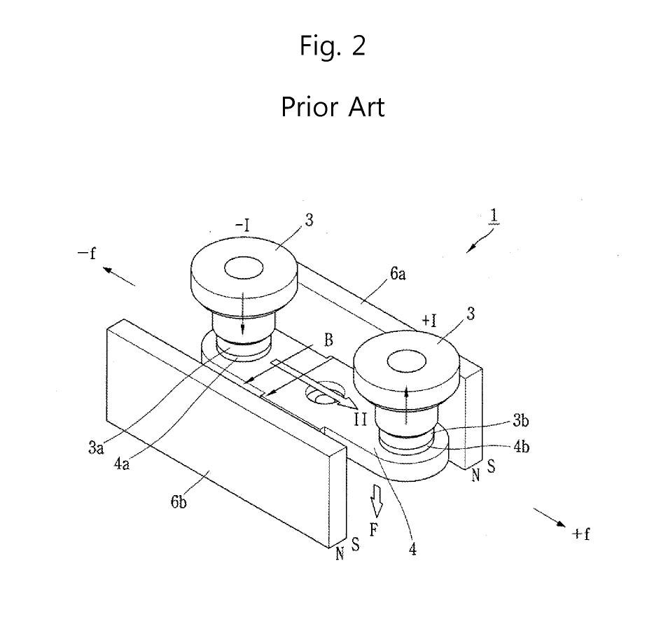

FIG. 3 is a planar view illustrating a magnetic flux density in FIG. 2;

FIG. 4 is a frontal view illustrating an upper part of a direct current relay according to an embodiment of the present invention;

FIG. 5 is a planar view illustrating an upper part of a direct current relay according to an embodiment of the present invention; and

FIG. 6 is a view illustrating a magnetic flux density in FIG. 5.

### DETAILED DESCRIPTION OF THE INVENTION

Description will now be given in detail of preferred configurations of a direct current relay according to the present invention, with reference to the accompanying drawings.

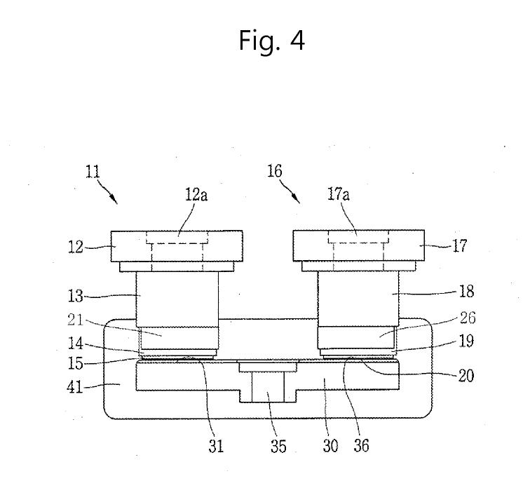

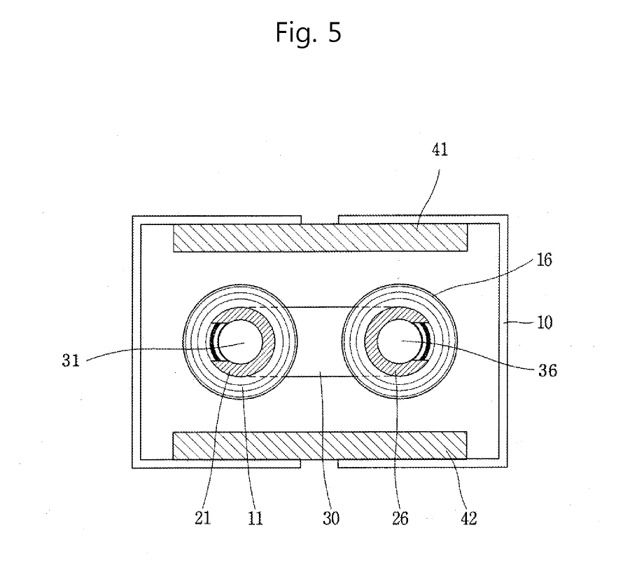

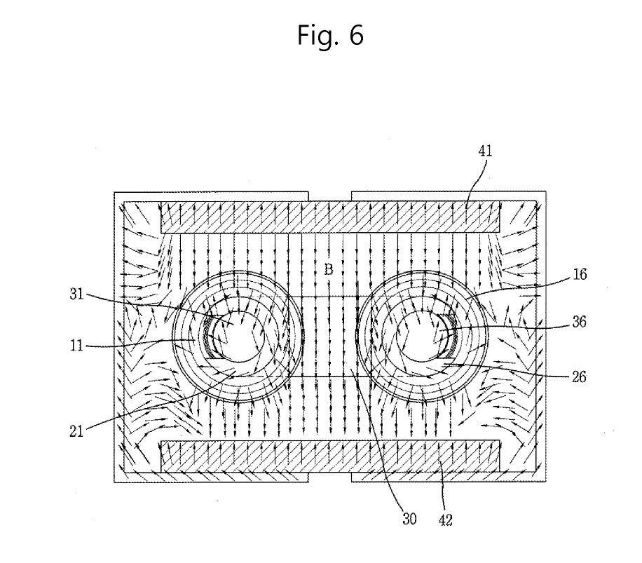

FIG. 4 is a frontal view illustrating an upper part of a direct current relay according to an embodiment of the present invention, FIG. 5 is a planar view illustrating an upper part of a direct current relay according to an embodiment of the present invention, and FIG. 6 is a view illustrating a magnetic flux density in FIG. 5.

A direct current relay according to an embodiment of the present invention includes a frame 10; first and second fixed contacts 11, 16 installed in a spaced manner with a predetermined distance therebetween; first and second magnetic substances 21, 26 provided to enclose a lower part of the first and second fixed contacts 11,16; a movable contact 30 movable to contact or to be separated from the first and second fixed contacts 11, 16, having a first movable contact 31 contactable to the first fixed contact 11, and having a second movable contact 36 contactable to the second fixed contact 16; and a pair of permanent magnets 41, 42 installed on long sides of the frame 10.

The first and second fixed contacts 11, 16 are installed at the frame 10 in a spaced manner with a predetermined distance therebetween. The first and second fixed contacts 11, 16 are formed of a material having an excellent conductivity, and they may be formed to have the same size and shape. The first and second fixed contacts 11, 16 may be formed so that head parts 12, 17, body parts 13, 18 and leg parts 14, 19 can form steps sequentially.

Terminal grooves 12a, 17a, which are connectable to a power side or a load side, are formed at the head parts 12, 17.

The body parts 13, 18 and the leg parts 14, 19 are formed to have a cylindrical shape. The body parts 13, 18 and the leg parts 14, 19 may be integrally formed without a step therebetween in an embodiment.

First and second contact parts 15, 20 are formed on a lower surface of the leg parts 14, 19. The first and second contact parts 15, 20 are parts where a current flows as the first and second contact parts 15, 20 come in direct contact with the movable contact 30.

First and second magnetic substances 21, 26 are provided at the leg parts 14, 19. The first and second magnetic substances 21, 26 may be configured as ferromagnetic substances such as iron (Fe), or may be configured as paramagnetic substances such as aluminum (Al). The first and second magnetic substances 21, 26 may be insertion-installed at an outer circumferential surface of the leg parts 14, 19 in the form of rings.

Each of the first and second magnetic substances 21, 26 may be formed to have a ‘C’ shape. Preferably, open parts of the first and second magnetic substances 21, 26 are installed so as to be toward outside. Under such a configuration, an external influence can be reduced, and an effect to concentrate a magnetic field to the first and second magnetic substances 21, 26 can be enhanced.

The movable contact 30 may be configured as a plate type body. The movable contact 30 contacts or is separated from the first and second fixed contacts 11, 16 with being moved up and down by an actuator (not shown). The movable contact 30 is provided with the first and second movable contacts 31, 36 at contact regions with the first and second contact parts 15, 20.

A pair of permanent magnets 41, 42 are installed on long sides of the frame 10. When viewed from a planar view of FIG. 5, the pair of permanent magnets 41, 42 are installed at two sides on the basis of the first and second fixed contacts 11, 16 and the movable contact 30. The first permanent magnet 41 may be an N-pole, and the second permanent magnet 42 may be an S-pole. A magnetic field (B) is set in a direction toward the second permanent magnet 42 from the first permanent magnet 41.

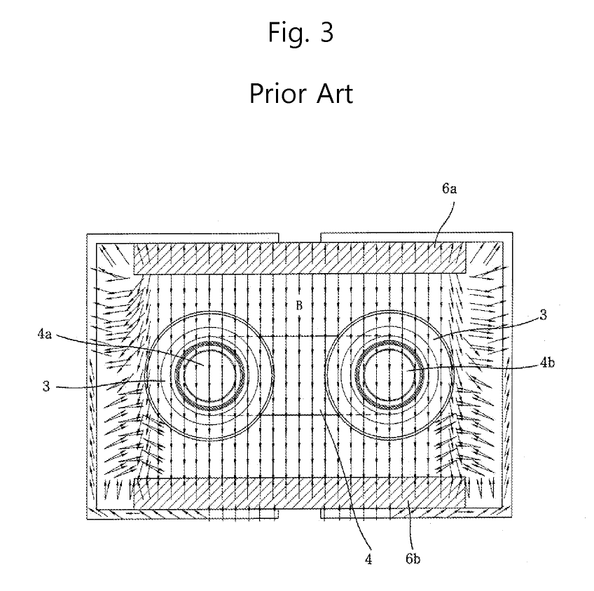

FIG. 3 illustrates a magnetic flux density in a direct current relay in accordance with the conventional art, and FIG. 6 illustrates a magnetic flux density in a direct current relay according to an embodiment of the present invention.

In the direct current relay according to an embodiment of the present invention, since the first and second magnetic substances 21, 26 are provided in a magnetic field (B) flowing from the first permanent magnet 41 to the second permanent magnet 42, a magnetic flux is concentrated onto the first and second magnetic substances 21, 26. Such a phenomenon occurs intensively around the first and second magnetic substances 21, 26. That is, a magnetic flux generated from the first permanent magnet 41 flows in a direction to concentrate to the first and second magnetic substances 21, 26, and then flows to the second permanent magnet 42. Thus, a magnetic flux flowing to the first and second movable contacts 31,36 is reduced. As a comparison result between FIG. 3 and FIG. 6, it can be shown that a density of a magnetic flux flowing on the first and second movable contacts 31, 36 has been significantly reduced, in the direct current relay according to an embodiment of the present invention. More specifically, a magnetic flux flowing from the first permanent magnet 41 to the second permanent magnet 42 interacts with a current flowing to the first and second movable contacts 31, 36. As a result, the magnetic flux receives a force by Fleming's left-hand law, so that a force to separate the first and second movable contacts 31, 36 from the fixed contacts 11, 16 can be reduced.

In the direct current relay according to an embodiment of the present invention, a magnetic flux flowing from the permanent magnet is concentrated to the first and second magnetic substances, since the first and second magnetic substances are provided below the first and second fixed contacts. As a result, an electronic repulsive force generated between the fixed contacts and the movable contacts can be reduced by the permanent magnet installed to extinguish an arc.

As the present features may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. A direct current relay, comprising:
a frame;
first and second fixed contacts spaced from each other with a predetermined distance therebetween;
first and second magnetic substances formed to enclose a lower part of the first and second fixed contacts;
a movable contact movable to contact or to be separated from the first and second fixed contacts, having a first movable contact contactable to the first fixed contact, and having a second movable contact contactable to the second fixed contact; and
a pair of permanent magnets installed on long sides of the frame.

2. The direct current relay of claim 1, wherein the first and second fixed contacts are formed so that head parts, body parts, and leg parts form steps sequentially, and
wherein the first and second magnetic substances are coupled to a circumferential surface of the body parts or the leg parts.

3. The direct current relay of claim 1, wherein each of the first and second magnetic substances is formed to have a ‘C’ shape.

4. The direct current relay of claim 3, wherein open parts of the first and second magnetic substances are installed so as to be toward outside.

5. The direct current relay of claim 1, wherein the first and second magnetic substances are configured as ferromagnetic substances, or are configured as paramagnetic substances.
